(19) United States
(12) Patent Application Publication
(10) Pub. No.: US 2020/0364632 A1
(43) Pub. Date: Nov. 19, 2020

(54) SYSTEM AND METHOD FOR AUTOMATED MONITORING OF MATERIAL MOVEMENT AND INVENTORY

(71) Applicant: NEWTRAX HOLDINGS INC., Quebec (CA)

(72) Inventors: Alexandre CERVINKA, Quebec (CA); Jean-Philip BOUCHARD, Quebec (CA)

(21) Appl. No.: 16/763,643

(22) PCT Filed: Nov. 14, 2018
(86) PCT No.: PCT/CA2018/051448

§ 371 Date: May 13, 2020

Related U.S. Application Data
(60) Provisional application No. 62/586,061, filed on Nov. 14, 2017.

(51) Int. Cl. G06Q 10/06; G06Q 10/08

(52) U.S. Cl. CPC G06Q 10/0631; G06Q 10/087

(57) ABSTRACT

A system and method to monitor material movement is provided. The method and system include automatically capturing data with minimal manual data entry or without any manual data entry, such system aiming at eliminating human errors or at least reducing to a minimum such errors. The system is generally configured to capture at least information in relation of to the location of loading/dumping of a vehicle and the net payload that was dumped by the vehicle.

### CROSS-REFERENCE TO RELATED APPLICATIONS

The present patent application claims the benefits of priority of U.S. Provisional Patent Application No. 62/586,061, entitled “System and method for automated monitoring of material movement and inventory” and filed at the United States Patent and Trademark Office on Nov. 14, 2018, the content of which is incorporated herein.

### FIELD OF THE INVENTION

The present invention generally relates to systems and methods for monitoring movement and inventory of material. More specifically, the present invention relates to systems and methods for automatically monitoring material movement in vehicles using different types of sensors.

### BACKGROUND OF THE INVENTION

Prime movers are known as mobile equipment manufactured by Original Equipment Manufacturers (OEMs) such as but not limited to Cat™, Sandvik™, Atlas Copco™, Volvo™, Komatsu™, etc. Such equipments are used to load and haul material. There are different versions of prime movers such as:
Rigid frame truck,
Articulated dumper truck,
Construction truck
Front End Loader
Scoop Tram aka Load Haul Dump (LHD)
Train or Locy's

Now referring to FIG. 1, examples of mobile equipments manufactured or prime movers by OEMs are show.

In most markets for loading and haulage equipment, such as the construction industry and quarries for aggregates, detailed tracking of material movement from original source to final destination is not important.

In this context, known payload monitoring systems on the market work in isolation to the other sensors on the machine and are designed to output the value of the load in the bucket when the dump occurs.

In base and precious metal mining however, detailed tracking of material movement from its original source to the plant where it will be processed is critical.

The concentration of metal(s) in the crushed rocks fed to the plant is highly diluted and metallurgists optimize the overall recovery process including the mix of chemicals based on specific assumptions about the ore blend that will be fed to the plant.

If the actual ore blend fed to the plant is significantly different from what was planned by the metallurgist, then recovery can drop by a few percentage points or more, which can mean a lost of several millions even hundreds of millions of dollars for the mining company.

Today, mine management works with inaccurate and untimely estimates of material source and inventory, because the estimates rely mainly on manual data entry and reconciliation. Another challenge of the industry is that planned operation typically change during a shift and such change may not be communicated to the operators. For instance, an operator may be instructed to load material in location A and to carry such material to the ore pass B. If the ventilation in location A is down, the LHD may not execute the task as planned. In such a scenario, the operator may get instructions to travel to another location to load material with a different gradeability. Since the rocks mined in different parts of the mine have different grades, the probability of the actual ore blend matching the planned ore blend at the plant is low.

Indeed, no solution exists to provide or collect payload data in real time, either developed by OEM manufacturer, such as but not limited to CAT™, Sandvik™ Atals Copco™, etc . . . ), 3^{rd} party manufacturer, such as but not limited to Loadman™, Stress-Tek/Vulcan VPG™, EcoTrack™, Cleral™, etc. or production control solution manufacturer.

The table below illustrates the typical mix of material re-handling one can expect in a large underground mine, where L=Loading and D=Dumping.

| Equipment Type | | Remuck/ | | | Truck | Truck |
|---|---|---|---|---|---|---|
| and Scenario/ | | Stock | Ore | Truck | Dump | Dump |
| Cycle | Stope | Pile | Pass | Loading | UG | Surface |
| LHD 1 | L | D | | | | |
| LHD 2 | L | | | D | | |
| LHD 3 | L | | D | | | |
| LHD 4 | | L | | D | | |
| LHD 5 | | L | D | | | |
| LHD 6 | L | | | | D | |
| LHD 7 | L | | | | | D |
| Truck/Train 1 | | | | L | D | |
| Truck/Train 2 | | | | L | | D |
| Skip | | | | | L | D |

Thus, there is a need for a system to monitor material movement aiming at automatically capturing information such as quantity loaded, from a first location to a second location without any manual data entry.

### SUMMARY OF THE INVENTION

The shortcomings of the prior art are generally mitigated by a system and method to monitor material movement.

In one aspect of the invention, the method and system generally comprise automatically capturing data with minimal manual data entry or without any manual data entry, such system aiming at eliminating human errors or at least reducing to a minimum such errors. The system is generally configured to capture at least information in relation of to the location of loading/dumping of a vehicle and the net payload that was dumped by the vehicle.

In another aspect of the invention, a method for real-time monitoring of material movement and inventory supported by a vehicle is provided. The method comprises reading load values of material supported by the vehicle at a first predetermined frequency, identifying position of the vehicle at a second predetermined frequency, detecting a loading event of material in the vehicle based on the read load values, determining the position of the vehicle at time of the loading event, detecting an unloading event of material in the vehicle based on the read load values and calculating in real time net load of the material that was unloaded by the vehicle.

The calculation in real time of the net load of the material further may comprise fetching material properties found at the determined position of loading of the vehicle from a data source comprising one or more relation between the material properties and position information of the material. The calculation in real time of the net load of the material may further comprise measuring the load of the material in transit.

The identification of the position of the vehicle at a second predetermined frequency may use position technologies.

The detection of the loading event of material in the vehicle further may comprise storing a time stamp of the loading event and the detection of the unloading event further comprising storing the read load value after the detected unloading event.

The method may further comprise determining the angle of a boom of the vehicle or may further comprise determining the calibration angle of the boom, the net load being calculated when the determined angle of the boom is over the determined calibration angle. The method may further comprise measuring the flexion of a portion of the vehicle, the detection of the loading or the unloading event of material in the vehicle further using the measured flexion of the portion of the vehicle. The method may further comprise measuring inclination of the vehicle, the detection of the loading or the unloading event of material in the vehicle further using the measured inclination of the portion of the vehicle.

The method may further comprise measuring wheel speed of the vehicle and calculating haulage intensity of the vehicle based on the measured wheel speed. Also, the first and second predetermined frequency may be the same.

In yet another aspect of the invention, a system for monitoring material movement supported by a vehicle in real-time is provided. The system comprises a localization module configured to provide the coordinates of the vehicle at a first predetermined frequency; a load measuring device configured to measure load values of the material supported by the vehicle at a second predetermined frequency and a processing unit. The processing unit is configured to detect an event of material loading in the vehicle based on the measured load values; store the load value after to the detected loading event, capture the coordinates of the vehicle at the time of the detected loading event, detect an event of material unloading in the vehicle based on the measured load values, store the load value after the detected unloading event, identify the loaded material based on the captured coordinates at the time of the loading event and calculate net load of the material unloaded during the detected unloading vehicle based on the loaded material and on the load values after the detected loaded and unloaded events.

The system may further comprise an angular position sensor configured to measure the angle of a portion of a vehicle. The portion of the vehicle for which the angle is measured may be a boom. The processing unit may further be configured to calculate the net load when the measured angle of the boom is greater than a predetermined calibration angle.

The load measuring device may further comprise a pressure sensor and the processing unit. The pressure sensor may measure pression of hydraulic cylinders of the vehicle. The load measuring device may further comprise a load cell configured to measure load of a portion of the vehicle. The said portion of the vehicle may be a bin.

The load measuring device further may comprise a load pin cell configured to measure load of a pivoting portion of the vehicle. The pivoting portion of the vehicle may be a hinge of a bin. The load measuring device may further comprise a transducer configured to measure flexion of a portion of the vehicle. The transducer may be underneath a portion of the vehicle adapted to receive the material. The said portion of the vehicle adapted to receive the material may be a bin.

The system may further comprise an inclination sensor configured to measure inclination of the vehicle. The processing unit may be further configured to use measured inclination of the vehicle to calculate net load of the material unloaded from the vehicle.

The system further may comprise wheel-based vehicle speed sensor. The processing unit may be further configured to use measured vehicle speed of one or more wheels of the vehicle to haulage intensity of the vehicle.

Also, the first and second predetermined frequencies may be the same, the vehicle may be a hauler or a truck.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 illustrates examples of prior art mobile equipments manufactured by OEMs.

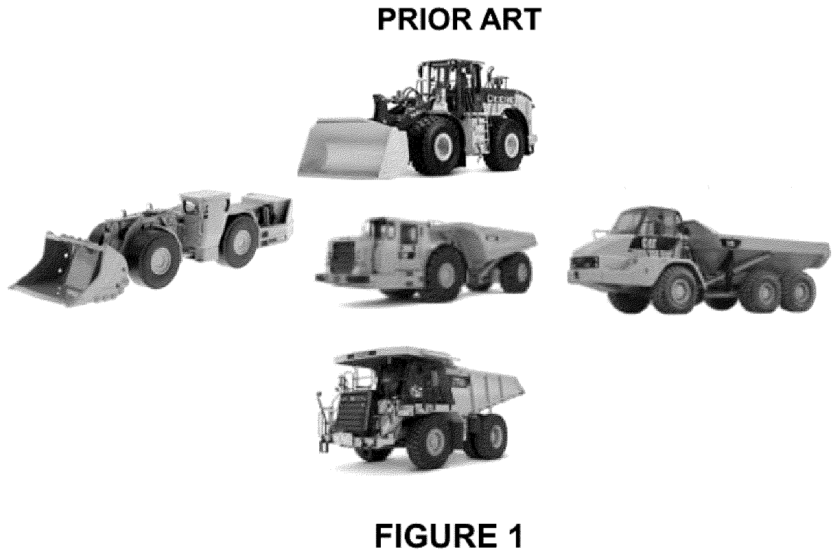

FIG. 2 is an illustration of mobile equipment equipped with an embodiment of a system to monitor material movement in accordance with the principles of the present invention.

FIG. 3 is a screenshot of data being collected in real-time from a hydraulically supported bucket using an embodiment of the system to monitor material movement in accordance with the principles of the present invention.

FIG. 4 is a screenshot of data being collected in real-time from a mechanically supported bucket using an embodiment of the system to monitor material movement in accordance with the principles of the present invention.

FIG. 5 is an illustration of an embodiment of a system to automatically track at least a portion of the material movement within a truck in accordance with the principles of the present invention.

FIG. 6 is an illustration of an embodiment of a system to automatically track at least a portion of the material movement using pins and load cells installed on a bin of a truck in accordance with the principles of the present invention.

FIG. 7 is an illustration of an embodiment of a system to automatically track at least a portion of the material movement using at least a transducer installed under a bin of a truck in accordance with the principles of the present invention.

FIG. 8 is a screenshot of data being collected in real-time from a bucket using an embodiment of the system to monitor material movement in accordance with the principles of the present invention.

FIG. 9 is a photograph of an embodiment of a system to automatically track movement and/or load of a bucket of a vehicle in accordance with the principles of the present invention.

### DETAILED DESCRIPTION OF THE PREFERRED EMBODIMENT

A novel system and method for automated monitoring of material movement and inventory will be described hereinafter. Although the invention is described in terms of specific illustrative embodiments, it is to be understood that the embodiments described herein are by way of example only and that the scope of the invention is not intended to be limited thereby.

A novel system to monitor material movement comprises automatically capturing data with minimal manual data entry or without any manual data entry is provided. Such system generally aims at eliminating human errors or at least reducing to a minimum such errors. The present system is configured to capture and store load data and to generally combine such data to tracking data of a vehicle. As an example, the loading data time enable detecting the location where the vehicle or equipment got loaded and unloaded. The said combined information (loading at a first location and unloading at a second location), may be collected or captured onboard of the equipment/vehicle using any data collection device or using real time payload data being merged with the location data. Such merge may be executed using any data fusion or database merging technique. The system is generally configured to capture at least the following information:
the location of the loading of a vehicle, such as a LHD. Such determination may require ore grade of payload, based on the ore grade of location in mine plan.
the location at which the vehicle has dumped. Such determination of the location may require to track progress of payload to surface, and therefore the ore grade of the rock sent to the plant for processing.
the net payload that was dumped by the vehicle, i.e. total payload—carryback. Such net pay load determination may require accurately measuring the inventory in transit.

The tracking of the vehicle location may be done using any type of positioning technologies, such as RFID or LiDAR positioning technologies combined with store-and-forward or real-time wireless communications. Understandably, any known type of positioning technologies may be used without restricting the scope of the present invention.

The interpolation of the ore grade in a specific stope, location or development face is generally available from a mine planning software.

The system may use any type of known LHD payload measuring systems. The system or method may further comprise:
calculating or capturing the loading time stamp. Such information generally allows to determine the loading location, such information being generally required to determine the payload ore grade;
capturing the post-dump payload information provided. In a typical prior art system, the payload information provided is the pre-dump payload. As several tons of wet rock may remain stuck at the bottom of the bucket post-dump and is carried back to a loading zone, the material movement data may be corrupted or at least erroneous.

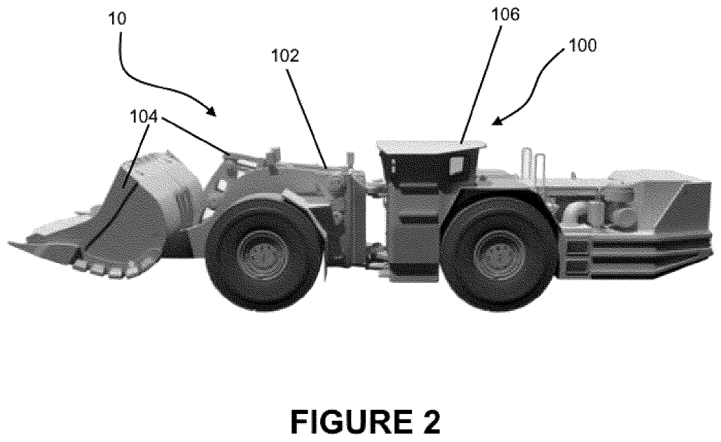

Referring now to FIG. 2, an exemplary vehicle 10 equipped with an embodiment of a system 100 to monitor material movement comprises automatically capturing data with minimal manual data entry or without any manual data is shown. The system 100 is configured to detect both the load and unload time stamps and to measure the net payload dumped, the monitoring sub-system may comprise at least:
an angular position sensor 102, typically positioned on a boom of the vehicle 10;
a pressure sensor 104, typically positioned on hydraulic cylinders of the vehicle 10 (lift and dump);
a central data logger and signal processing unit.

In other embodiments, the system 100 may comprise additional sensors may configured to be simultaneously monitored by the central data logger and/or signal processing unit. As an example, the additional sensors may comprise:
an inclination sensor of the vehicle 10 or LHD frame or structure, such inclination sensor aiming at providing context for the pressure sensor and therefore to increase payload measurement accuracy;
a wheel-based vehicle speed sensor, such sensor being typically configured to measure haulage intensity Key Performance Indicator (KPI), since in underground mines the route may significantly vary from one load to the next.

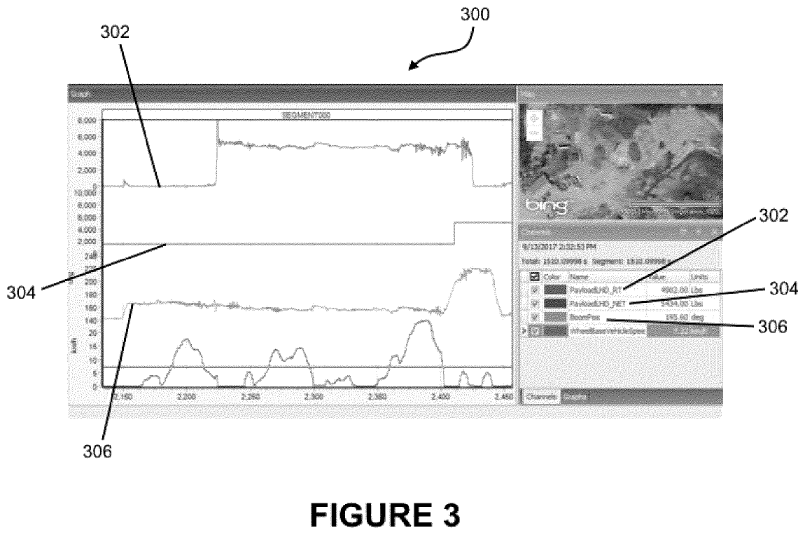

Referring now to FIG. 3, a chart 300 of the data collected as a function of the time by the sensors of an exemplary hydraulically supported bucket is shown. In some embodiments, the data of at least some or all the sensors is preferably collected in real time A 1 Hz and the key signals for a hydraulically supported bucket are shown in FIG. 3. The signals may comprise:
PayloadLHD_RT [lbs] 302: the payload value in real time. The precision of such value may vary as a function of the angle of the boom (see BoomPos [Deg]). As a rule of thumb, the further the value differs from the calibration angle, the lower is the precision. Such payload value generally allows to define the loading and the loading locations.
PayloadLHD_NET [lbs] 304: the payload value calculated by the system when the angle of the boom is over the calibration angle.
BoomPos [Deg] 306: The angle of the loader boom. The loader generally hauls with the boom between 165 to 170 degrees. The horizontal position is generally referred as 180 degrees and the calibration is typically 194 degrees.

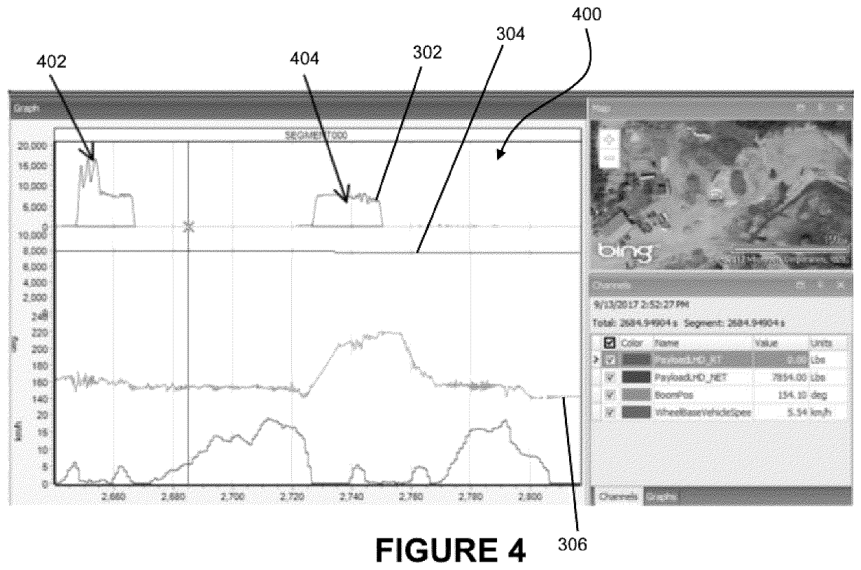

Referring now to FIG. 4, a chart of the data collected by the sensors 400 of an exemplary mechanically supported bucket as a function of the time is shown. In some embodiments, the data of at least some or all the sensors is preferably collected in real time @ 1 Hz and the key signals for an exemplary mechanically supported bucket are shown in FIG. 4. The payload value signal may be analysed to identify loading 402 and unloading events 404 (see FIG. 4).

When a loading event 402 is detected, the system logs the location of the vehicle or LHD in the payload record and the grade of the ore at that location may be extracted from one or more mine plans.

When a dumping or unloading event 404 is detected, the system subtracts the payload after the dump from the payload just before the dumping; the result being the net payload. Such net payload (typically as tons) is subtracted from the inventory of ore in the stope and added to the inventory in the dump location.

In some embodiments, since LHDs are typically used for other tasks than Load-Haul-Dump of ore or other material, such as but not limited to moving an oversize rock from one location or draw point to another or carrying other things, payloads may be further filtered down to only cycles from a valid loading zone to a valid dumping zone, such as using any type of localization technologies.

In other embodiments, the present system may be used with trucks to automatically track at least portion of the material movement.

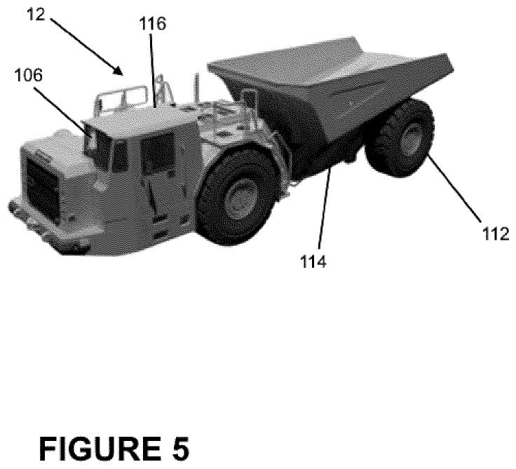

Now referring to FIGS. 5 to 7, an exemplary truck 12 payload monitoring sub-system 110 is illustrated. The sub-system is generally configured to detect both the loading and unloading time stamps and to measure the net payload dumped by the truck. In some embodiments, the sub-system comprises:
different combinations of load cell 114, pin cell 112 and/or deflection transducer for trucks, as shown in FIGS. 5 to 7;
at least one central data logger and signal processing unit.

Referring to FIG. 5, the truck payload monitoring sub-system typically comprises a plurality of load cells 114 configured to capture data about the weight of the bin and/or one or more load pin cell 112 configured to detect the load at the pivot location of the bin. The sub-system may further comprise a display unit or scoreboard indicator 116 adapted to display the number of tons of material that was loaded and unloaded in the truck 12 bin. The sub-system may further comprise a payload monitor and/or encoder 106. All components (such as sensors, display unit and/or monitor encoder) are generally connected to a central processing unit which capture and analyze the data received in real time.

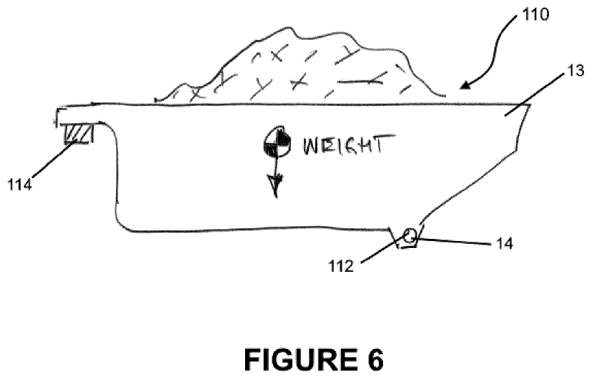

Referring to FIG. 6, an embodiment of a truck 12 equipped with a payload monitoring sub-system 110 using a load cell 114 and load pin cells 116 is shown. The system 110 typically comprises one or more pin load cells at the pivoting point 14 of the bin or body 13 of the truck 12 and a load cell 114 installed at a location to calculate weight when the bin is not being dumped. The load cell 114 is typically installed at a pressure point between the bin 13 and the truck 12.

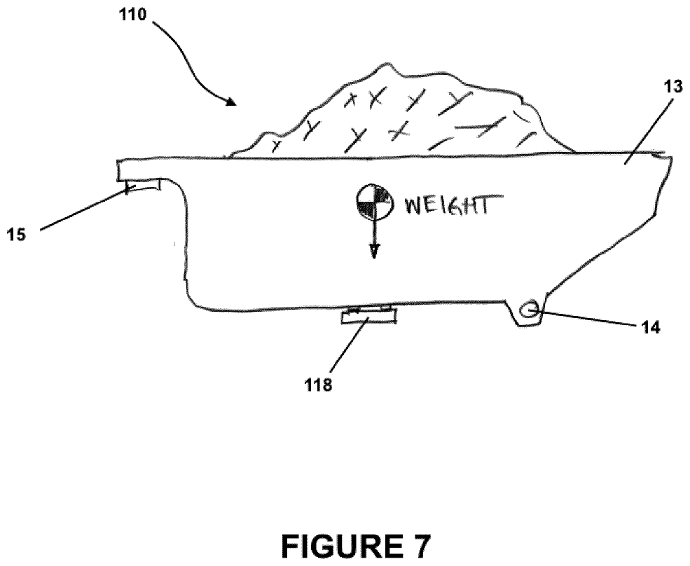

Referring to FIG. 7, a truck 12 equipped with another embodiment of a payload monitoring sub-system 110 using a transducer 118 is shown. The system typically comprises one transducer 118 configured to measure the flexion of the body or the bin of the truck 12. The transducer is typically installed underneath the bin or body of the truck.

In yet another embodiment, similarly to LHD embodiments, additional sensors may be installed on the truck 12 to simultaneously monitor the truck activities. Such data is generally communicated to the central data logger and/or to the signal processing unit. The additional sensors may comprise one or more of the following sensors:
inclination sensor of the truck frame. Such sensor generally aims at providing context for the load cells and therefore to increase payload measurement accuracy;
wheel-based vehicle speed sensor. Such sensor typically aims at measuring haulage intensity KPI, since in underground mines the route may significantly vary significantly from one load to the next.

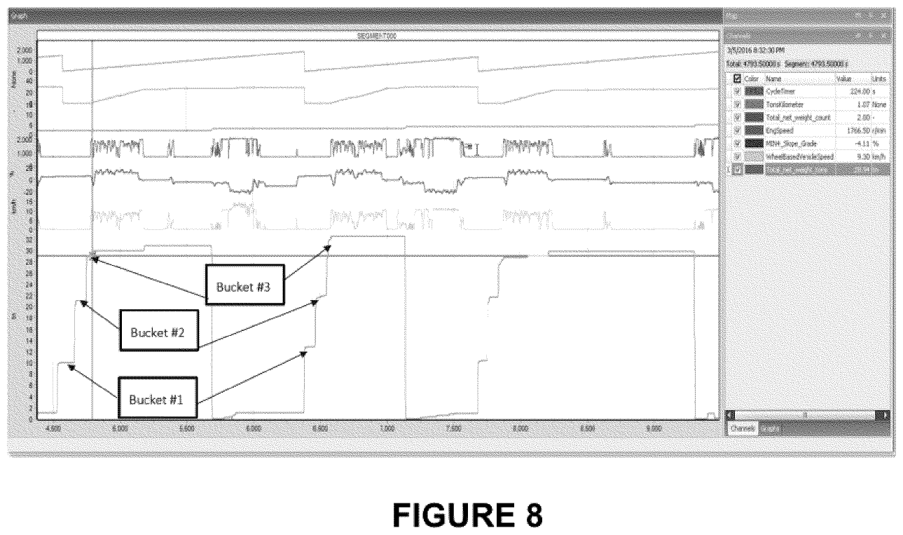

Referring now to FIG. 8, a chart of the data collected by the sensors as a function of time of an exemplary payload monitoring sub-system 110 for a truck 12 is shown. In some embodiments, the data of at least some or all the sensors is preferably collected in real time A 1 Hz and the key signals for the payload monitoring sub-system 110 are shown in FIG. 8. In the exemplary chart of FIG. 8, the total net weight signal may be analysed to identify loading of three (3) buckets of material in the monitored truck (see FIG. 8).

The real-time payload monitoring system 110 may further comprise a weight indicator scoreboard 116 visible to the LHD operator during loading. The weight indicator 116 generally aims at providing a mean for the LHD operator to add just the right quantity, volume or load of material, such as rock. Such scoreboard 116 generally aims at increasing the productivity of the operators and, ideally, maximizes such productivity. Such productivity such be limited to a level which optimize the productivity but limit or at least reduce maintenance problems.

Such systems for continuous payload monitoring systems 100 or 110 allow the collection of data from each monitored vehicle 10 or 12. The data of each vehicle 10 or 12 may be aggregated by the data logger and the following exemplary KPIs may also be monitored:
The number of buckets used to load a truck
The load to load cycle time
The distance hauled loaded
The distance hauled empty
The time hauled loaded
The time hauled empty
Speed hauling loaded
Speed hauling empty
The haulage intensity [Tn×km/h]

Such KPIs generally aims at providing useful data for mine management or mine operators.

Lastly, real-time visibility on the material movement enables short interval control optimization of the mine plan, as discussed in academic papers such as: https://www.gerad.ca/en/papers/G-2016-26/view.

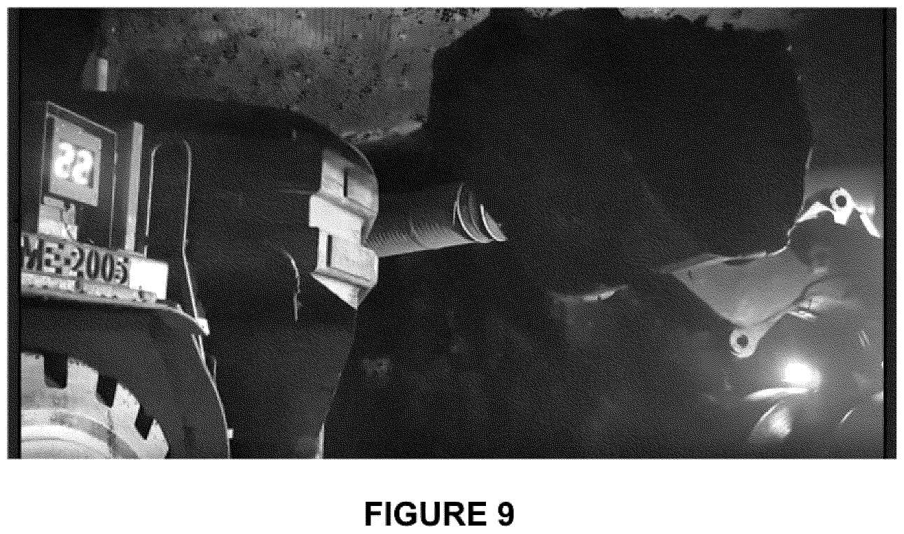

Now referring to FIG. 9, an embodiment of a system to automatically track movement and/or load of a bucket 100 or 110 of a vehicle in accordance is shown.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A method for real-time monitoring of material movement and inventory supported by a vehicle, the method comprising:
a) reading load values of material supported by the vehicle at a first predetermined frequency;
b) identifying position of the vehicle at a second predetermined frequency;
c) detecting a loading event of material in the vehicle based on the read load values;
d) determining the position of the vehicle at time of the loading event;
e) detecting an unloading event of material in the vehicle based on the read load values;
f) calculating in real time net load of the material that was unloaded by the vehicle.

2) The method of claim 1, the calculation in real time of the net load of the material further comprising fetching material properties found at the determined position of loading of the vehicle from a data source comprising one or more relation between the material properties and position information of the material.

3) The method of claim 1, the calculation in real time of the net load of the material further comprising measuring the load of the material in transit.

4) The method of claim 1, the identification of the position of the vehicle at a second predetermined frequency using position technologies.

5) The method of claim 1, the detection of the loading event of material in the vehicle further comprising storing a time stamp of the loading event and the detection of the unloading event further comprising storing the read load value after the detected unloading event.

6) The method of claim 1, the method further comprising determining the angle of a boom of the vehicle.

7) The method of claim 6, the method further comprising determining the calibration angle of the boom, the net load being calculated when the determined angle of the boom is over the determined calibration angle.

8) The method of claim 1, the method further comprising measuring the flexion of a portion of the vehicle, the detection of the loading or the unloading event of material in the vehicle further using the measured flexion of the portion of the vehicle.

9) The method of claim 1, the method further comprising measuring inclination of the vehicle, the detection of the loading or the unloading event of material in the vehicle further using the measured inclination of the portion of the vehicle.

10) The method of claim 1, the method further comprising:
a) measuring wheel speed of the vehicle;
b) calculating haulage intensity of the vehicle based on the measured wheel speed.

11) The method of claim 1, wherein the first and second predetermined frequency are the same.

12) A system for monitoring material movement supported by a vehicle in real-time, the system comprising:
a) a localization module configured to provide the coordinates of the vehicle at a first predetermined frequency;
b) a load measuring device configured to measure load values of the material supported by the vehicle at a second predetermined frequency;
c) a processing unit configured to:
i) detect an event of material loading in the vehicle based on the measured load values;
ii) store the load value after to the detected loading event;
iii) capture the coordinates of the vehicle at the time of the detected loading event;
iv) detect an event of material unloading in the vehicle based on the measured load values;
v) store the load value after the detected unloading event;
vi) identify the loaded material based on the captured coordinates at the time of the loading event;
vii) calculate net load of the material unloaded during the detected unloading vehicle based on the loaded material and on the load values after the detected loaded and unloaded events.

13) The system of claim 12, the system further comprising an angular position sensor configured to measure the angle of a portion of a vehicle.

14) The system of claim 13, the portion of the vehicle for which the angle is measured being a boom.

15) The system of claim 14, the processing unit being further configured to calculate the net load when the measured angle of the boom is greater than a predetermined calibration angle.

16) The system of claim 12, the load measuring device further comprising a pressure sensor.

17) The system of claim 16, the pressure sensor measuring pression of hydraulic cylinders of the vehicle.

18) The system of claim 12, the load measuring device further comprising a load cell configured to measure load of a portion of the vehicle.

19) The system of claim 18, the portion of the vehicle being a bin.

20) The system of claim 12, the load measuring device further comprising a load pin cell configured to measure load of a pivoting portion of the vehicle.

21) The system of claim 20, the pivoting portion of the vehicle being a hinge of a bin.

22) The system of claim 12, the load measuring device further comprising a transducer configured to measure flexion of a portion of the vehicle.

23) The system of claim 22, the transducer being underneath a portion of the vehicle adapted to receive the material.

24) The system of claim 23, the portion of the vehicle adapted to receive the material being a bin.

25) The system of claim 12, the system further comprising an inclination sensor configured to measure inclination of the vehicle.

26) The system of claim 25, the processing unit being further configured to use measured inclination of the vehicle to calculate net load of the material unloaded from the vehicle.

27) The system of claim 12, the system further comprising wheel-based vehicle speed sensor.

28) The system of claim 27, the processing unit being further configured to use measured vehicle speed of one or more wheels of the vehicle to haulage intensity of the vehicle.

29) The system of claim 12, the first and second predetermined frequencies being the same.

30) The system of any one of claims 12 to 29, the vehicle being a hauler.

31) The system of any one of claims 12 to 29, the vehicle being a truck.
